(19) United States
(12) Patent Application Publication
(10) Pub. No.: US 2010/0291329 A1
(43) Pub. Date: Nov. 18, 2010

(54) IN-MOULD LABEL AND METHOD FOR MANUFACTURING THEREOF

(75) Inventor: Eric Di Duca, Luxembourg (LU)

Correspondence Address: BAKER & DANIELS LLP, 300 NORTH MERIDIAN STREET, SUITE 2700, INDIANAPOLIS, IN, 46204, US

(73) Assignee: I.S.D.I S.A., Luxembourg (LU)

(21) Appl. No.: 12/744,286

(22) PCT Filed: Nov. 23, 2007
(86) PCT No.: PCT/EP2007/062745

§ 371 Date: Aug. 9, 2010

(51) Int. Cl. B32B 3/10; B32B 38/14; B29C 45/16; B29C 49/00; B29C 51/12; B32B 1/00

(52) U.S. Cl. 428/35.2; 156/275.5; 156/277; 264/454; 264/478; 264/484; 264/509; 264/241; 428/34.1; 428/35.7; 428/201

(57) ABSTRACT

The present invention concerns an in mould label comprising a polymeric or cellulosic carrier base film (1) having a first decorative surface (1a) and a second, backing surface (1b), said label comprising a pattern (3) printed on said first decorative surface (1a) thereof, said printed first surface (1a) being laminated with a transparent protective top film (2), affixed thereto by means of an adhesive (4), the printed pattern (3) being visible through said transparent protective top film (2). It also concerns a method for manufacturing such a label and a method for incorporating it onto the surface of a polymeric article.

### TECHNICAL FIELD

The present invention relates to in mould labels (IML) which are particularly wear resistant and economical. It also concerns a method for manufacturing said labels and a method for producing polymeric articles comprising said in mould label.

### BACKGROUND OF THE INVENTION

In mould labels, commonly referred to as IML are well known in the art and comprise a carrier base, generally consisting of a polymeric or cellulosic carrier film, on which a decorative pattern or a written message is printed; a protective varnish is then applied as a top layer to protect the decorative pattern (cf. FIG. 1(a)). The thus obtained label is then positioned against a wall of a mould for injection moulding or for blow moulding, held in place by means known in the art, such as electrostatic forces or vacuum suction, and a polymeric article is moulded by injecting a mass of polymeric melt or by blowing a polymeric parison against the mould walls on which the IML is applied. Examples of such labels can be found in EP-A-894600 and DE-A-19619462. The adhesion of such labels to the polymeric article can be enhanced by applying a heat sealable layer (a film or a coating) onto the backing side (i.e., not printed surface) of the IML which is to be in contact with the polymeric article as illustrated in FIG. 1(b) and disclosed e.g., in EP-A-787581, W02001/007234, US2001 /028952, W02003/067561, EP-A-1480189, US2002/0050319. Further functionalities were added to the latter type of in mould labels in EP-A-1457301, W020006/003949, and DE-A-10220502 by incorporating an electronic component such as a chip sandwiched between the backing of the carrier film and a second film which is to be in contact with the polymeric article.

The above described in mould labels are greatly advantageous over traditional labels to be applied to an article after manufacturing thereof in that, on the one hand, the label is intimately bonded to the article and therefore highly resistant to ripping and, on the other hand, in terms of logistics since the polymeric articles to be labelled do not need to be stored and transported to the premises where traditional labels are to be applied. If the carrier of IML's is highly resistant to wear, however, the same does not apply to the printed pattern which is protected solely by a varnish. If a varnish is sufficient to protect the printed pattern under “normal” or light conditions of use, it is unsatisfactory when the article is exposed to more severe conditions of wear such as encountered by vessels repeatedly washed in a dishwasher, car parts hit by chips projections, luggage (mis-)handled in airports, surfaces exposed to UV light, boat parts in contact with salt water, equipment exposed to sand projections, etc.

To improve the wear resistance of the printed pattern on an IML it has been proposed to use a transparent carrier and simply print the pattern in reverse so that it can be recognized when seen through the transparent carrier. The thus obtained IML is then positioned into the mould such that the printed side thereof is in contact with the injected or blown polymer, so that the printed matter is sandwiched between the polymeric article and the transparent carrier, protected from the environmental aggressions by the latter as illustrated in FIG. 1(c) (cf. e.,g., WO2007/014588, GB-A-2426226). Though solving the problem of wear resistance of the printed pattern, this solution has some drawbacks. First the carrier base must necessarily be transparent, since the printed pattern is to be seen through it. This means that the pattern must be printed in reverse which requires the reprogramming of the printing equipment so as to apply the design in a mirror fashion and mostly requires what is commonly called a “covering white” in order to enhance the colour contrast. Finally, the printing inks show little affinity with the polymers mostly used in injection moulding and blowmoulding such as polyolefins (e.g., PE, PP), polyesters (e.g., PET, PEN), polystyrenes, etc. It follows that satisfactory adhesion between the polymeric article and the IML is possible only if a substantial fraction of the label is not covered with printing inks, such as comprising text only or very simple linear decorative patterns.

To overcome the problem of adhesion of the latter IML's, it has been proposed in EP-A-627290, EP-A-694377, U.S. Pat. No. 5,512,227, U.S. Pat. No. 5,705,255, EP-A-471854, EP-A-387883, and WO2007/014588 to apply an adhesion enhancing polymeric layer to the printed side of the label as illustrated in FIG. 1(d). Though satisfactory in terms of adhesion, it remains that the carrier base must be transparent and the pattern is to be printed in reverse, thus requiring the reprogramming of the printing equipment and the re-designing of the pattern, to inter alia include a so called “covering white”. Furthermore, since the selection of the carrier base material is limited by the affinity thereof to the printing inks, it is difficult to modify it with additives in order to add functionalities to the label such as reactivity to temperature, pH, moisture, light, etc., colouring, barrier to UV-light, solvents, gases, and so on, The present invention solves these problems and others as will be explained below.

### SUMMARY OF THE INVENTION

The present invention is defined in the appended independent claims. Preferred embodiments are defined in the dependent claims. The in mould label of the present invention comprises a carrier film comprising on a first decorated surface thereof a decorative pattern printed positively and a second, transparent film applied on top of said first decorated surface by means of an adhesive, such that the printed pattern can be seen through the second, transparent film.

By decorative pattern is meant any printed pattern including writings, figurative or non figurative motives, bar codes, etc. A decorative pattern may be in black and white or in colours, or can include inks reactive to an external excitation such as exposure to some specific wavelengths, heat, etc.

A pattern is defined as being “positively” printed when said pattern is meant to be seen with the carrier on which it is printed laying under the decorative pattern. Conversely, a pattern is considered to be printed “in reverse” when it is meant to be seen by transparency through the carrier on which it was printed.

Either the adhesive holding the second, transparent film to the first carrier film, or said second, transparent film itself may contain additives to add functionalities to the label. In particular, the following types of additives may be added to the label: UV-light absorbers, additives reacting to changes of the pH, temperature, moisture, or radiation. Additives enhancing the barriers properties to gases, solvents, etc. can easily be incorporated in the second, transparent film, as long as the printed pattern can still be satisfactorily distinguished by transparency through said second top film.

Printing conditions on a carrier film are very tricky to control, in particular when dealing with carrier films made of low surface energy materials such as polyolefins.

The slightest change in composition of the film may easily disrupt printability of the carrier film. For this reason, incorporating the additives in the second, transparent film, or in the adhesive is advantageous over incorporating them into the first carrier film in that once the printing materials and parameters are optimized, various functionalities may be added to the label without having to vary the conditions of printing. Furthermore, the use of some additives such as e.g., UV-light absorbers make sense only if the additive is positioned between the UV-source and the printed pattern, so that any label of the type depicted in FIGS. 1(c) and 1(d) would necessarily require the incorporation of such additives into the carrier film (1), with the inconvenience explained above.

A method for manufacturing an in mould label according to the present invention comprises a first, optional step of (a) pre-treating the surface of a polymeric carrier base film having a first decorative surface and a second, backing surface; followed by (b) printing a positive pattern onto said first surface of the carrier base film; the thus obtained printed pattern may (c) optionally be dried or cured;
subsequently (d) an adhesive is coated onto the printed surface of the carrier film and/or onto a surface of a second transparent film, followed by (e) lamination of the printed carrier film with said second, transparent film; the adhesive is then (f) cured to yield a multilayered in mould label according to the present invention, comprising a pattern visible through said second, transparent film.

This process is preferably, but not necessarily, run continuously on an apparatus comprising (a) a supply unit delivering a carrier film through the following stations: (b) an optional pretreatment station for treating a first surface of the carrier film; (c) a printing station to apply a printing pattern onto said first surface of the carrier film; (d) an optional drying station for drying or curing the printed pattern; (e) a station for applying an adhesive onto said printed, first surface of the carrier film or onto the surface of a second, transparent film, or both; at this point, the printed carrier film is ready for lamination with a said second, transparent film supplied by (f) a second supply unit delivering a said transparent film to (g) a laminating station for laminating said transparent film onto the printed surface of the carrier film; the adhesive is then cured in (h) a curing station; and the thus obtained laminated labels of the present invention are collected at (i) a collect unit.

One advantage of the present invention is that an apparatus as illustrated in FIG. 6 for the manufacturing of standard in mould labels as depicted in FIG. 1(a) can be adapted very easily and at minor costs to become suitable for the manufacturing of the claimed in mould labels.

The in mould labels manufactured as explained above can then be cut to the desired dimensions and positioned into a mould for injection moulding or blowmoulding, the second, transparent film being in contact with the mould wall. Adhesion of the label to the mould walls can be enhanced by vacuum suction or, preferably, by electrostatically charging the label prior to its positioning into the mould. The polymer melt or the reactive resin of the article to be manufactured is then injected into the mould and contacts the backing surface of the label, which is thus incorporated into the manufactured polymeric article. Similarly a polymeric parison is blown in a blowmoulding mould until it contacts the mould walls and thus incorporates the in mould label. The article thus produced is extracted and is ready for shipment.

An article produced with the process of the present invention is advantageous in that it comprises a label highly resistant to tearing, since it is incorporated into the bulk of the article, and to wear as the printed pattern is protected by the top transparent film.

Further details and advantages of the present invention are explained in the next section. The Figures are only meant to illustrate the invention and are not intended to limit the scope of the claims.

### BRIEF DESCRIPTION OF THE FIGURES

FIG. 1(a) to (d) shows various embodiments of in mould labels known in the art applied to a polymeric article.

FIG. 2(a)&(b) shows an embodiment of an in mould label of the present invention and the same applied to a polymeric article.

FIG. 3(a)&(b) shows another embodiment of an in mould label of the present invention and the same applied to a polymeric article.

FIG. 4(a)&(b) shows further embodiments of labels comprising an electronic component sandwiched between two films.

FIG. 5 shows the different steps to manufacture a label according to the invention (steps (a) to (c)) and to integrate it into a polymeric article (steps (d) to (f)).

FIG. 6 shows a known apparatus for producing an in mould label according to FIG. 1(a).

FIG. 7(a) to (c) shows various apparatuses suitable for producing an in mould label of the present invention.

### DETAILED DESCRIPTION OF THE INVENTION

(a) The label and manufacturing thereof

The carrier film (1) of the label of the present invention can be cellulosic, like paper or cardboard, or can be polymeric. In particular, the following polymers are suitable as carrier films: polyolefins such as polyethylene (PE) (high and low density), polypropylene (PP); polystyrenes (PS) such as acrylonitrile butadiene styrene (ABS); polyesters such as polyethylene terephtalate (PET), polyethylene naphtalate (PEN); polyvinyl chloride (PVC); polyamides; epoxies; etc., and combinations, blends, and/or copolymers thereof.

Polymeric carrier films are usually extruded and may be homogeneous or alternatively may comprise several laminate obtained by co-extrusion of various polymers. In the present context, however, a polymeric film is considered as forming a single unit regardless of whether it comprises a single or several co-extruded layers. For the point of view of the label manufacturer, this makes sense since the films are delivered ready-to-use in spools, and one spool mounted in the manufacturing apparatus corresponds to one layer in the in mould labels to be produced.

The thickness of the carrier film may vary according to the applications. For economical reason, and sometimes for weight reasons, the thinner the label the better. The carrier film, however, must be strong enough to resist the printing operation, and to give the final label sufficient integrity to be handled and positioned into the mould without wrinkling or folding. Typically, the thickness of the carrier film may vary between 20 and 150 μm, preferably between 40 and 80 μm, and most preferably between 45 and 75 μm. For a polypropylene film of low density, a thickness of 50 μm corresponds to about 27 g/m².

The first surface (1a) of carrier film (1) may advantageously be pre-treated by e.g., plasma, corona, or flame treatment prior to receiving the printed pattern in order to enhance adhesion with the printing inks and dyes. To this effect, an apparatus for manufacturing a label according to the present invention would advantageously comprise a pre-treatment station 11.

The printed pattern (3) can be applied onto the carrier film (1) in a printing station (12) by any means known in the art such as silk screen printing, gravure printing, offset printing, flexographic printing, ink jet printing, laser printing, thermal transfer, engraving, and the like. Since the printed pattern is subsequently covered with a second, transparent film (2) which protects it from the environment, the sole requirement on the inks and dyes to be used is their compatibility with the carrier film (1). Suitable inks and dyes may be selected among any of the well known inks and dyes known in the art, and can be water based, solvent based or dry powdered, depending on the printing technique used as listed above and which dry by exposure to air, UV, heat, etc.

The printed pattern (3) can be a written message, a decorative pattern figurative or not, a bar codes, and the like and combinations thereof. Depending on the type of ink or dye used, a drying step may be required in drying station (13), equipped with heating means (IR, resistance, convection, etc.), UV-lights, an the like. According to the present invention, the area of the label covered by the printed pattern is not limited and can extend over the whole area thereof with no detriment to the adhesion between the label and the polymeric article.

An adhesive (4) is then applied onto the printed surface (1a) of the carrier film (1), and/or onto a surface of a second, transparent film (2) in adhesive station (14). The adhesive can be applied by spraying means, rolls, curtain coating, and any method suitable for coating or printing the surface of a film with an adhesive. Any adhesive known in the art which is transparent can be used in the present invention depending on the materials used and the requirements of the ILML upon use.

Said second, transparent film (2) is then laminated onto the printed surface of the carrier film (1). It must be transparent because the printed pattern is to be seen therethrough when the label is integrated in an article. The transparent film (2) can be made of any material selected from polyolefins such as polyethylene (PE) (high and low density), polypropylene (PP); polystyrenes (PS) such as acrylonitrile butadiene styrene (ABS); polyesters such as polyethylene terephtalate (PET), polyethylene naphtalate (PEN); polyvinyl chloride (PVC); polyamides; epoxies; etc., and combinations, blends, and/or copolymers thereof.

The thickness of the transparent film (2) is less critical than the one of the carrier film (1) and may vary according to the applications. For economical reason, and sometimes for weight reasons, the thinner the label the better. Typically, the thickness of the transparent film (2) may vary between 20 and 150 μm, preferably between 20 and 50 μm.

An advantage of the present invention is that additives can be included to the top transparent film (2), thus adding functionalities to the label without affecting the affinity of the carrier film (1) towards the printing inks at the printing conditions used. For example, different visual aspects of the label can be obtained very easily by simply using a transparent film (2) coloured in different hues, yielding labels with the same printed pattern but with different colours. Further, the transparent film (2) may be loaded with additives reactive to environmental changes by changing colours when exposed to variations in pH, temperature, radiation wavelength, humidity, etc. The barrier properties of the top transparent layer can also be enhanced with additives, such as UV-light absorbers, and additives for lowering the permeability to gases, antistatic agents, etc. Continuous transparent films loaded with any of the additives mentioned above are readily available in the market and can be selected without any concern about printability or adhesion to the polymeric article.

The carrier film (1) must balance good printability and good adhesion to the polymeric article to which it is to be incorporated. The former requirement is essential and, in case adhesion of the carrier film to a given polymeric article were to be unsatisfactory, it is possible to enhance it by applying a heat sealable layer (6) onto the backing side (1b) of the IML which is to be facing the polymeric article as illustrated in FIG. 3. Said layer (6) can be a coating or an additional film and is to be selected as a function of the material of the article to which the IML is to be incorporated as explained in EP-A-787581, WO2001/007234, US2001/028952,WO2003/067561, EP-A-1480189, US2002/0050319.

The label of the present invention can comprise further functionality by integrating therein an electronic component (7) such as a chip, a transponder, and the like between the carrier film (1) and the transparent film (2) as illustrated in FIG. 4(a). In order to mask said electronic component to the observer, transparent film (2) may comprise a printed area covering said component. Preferably, the printed area is applied to the surface of film (2) in contact with the electronic component. To ensure the planarity of the label surface it is possible to add an intermediate film (8) comprising a pre-cut opening to accommodate the electronic component (7) as illustrated in FIG. 4(b). The intermediate film (8) must be transparent and serves to compensate for the thickness of the electronic component.

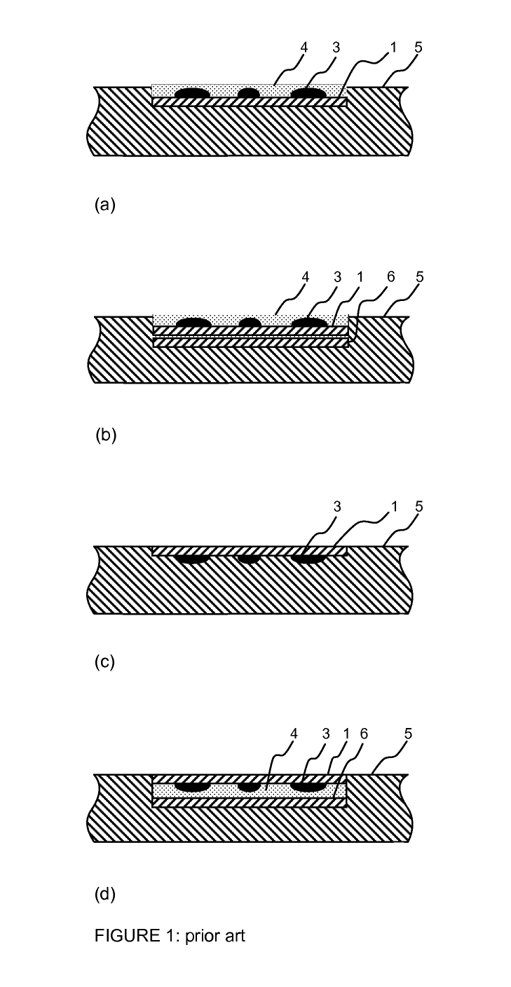

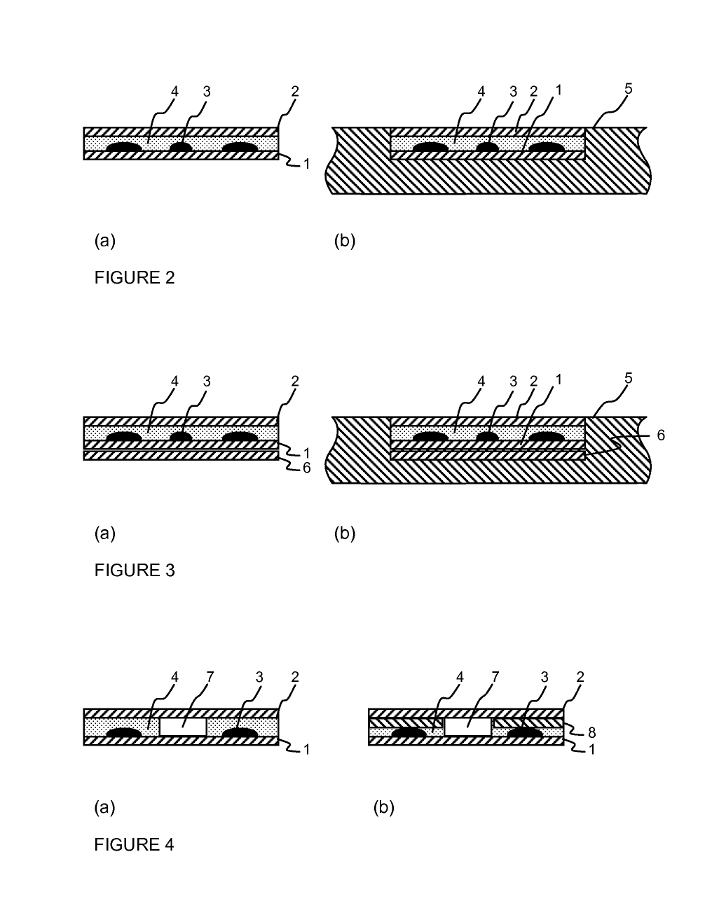

The in mould labels of the present invention are advantageously manufactured continuously. This can be achieved by using an apparatus as illustrated in FIG. 7(a)&(c) which comprises a supply reel (21) to supply the carrier film (1) from a spool and a driven collection reel (22) to wind the manufactured labels in a second spool. The surface (1a) to be printed of the carrier film (1) may first be treated in pre-treatment station (11) to enhance adhesion to the printing inks and dyes. Station (11) may be a corona, plasma, or flame treatment station. The carrier film (1) is then passed through a printing station (12) programmed to apply the printed pattern (3) positively onto the first surface (1a) thereof. Depending on the type and amounts of inks or dyes used a drying station (13) may be necessary. The drying station may comprise UV-light lamps or heating means, such as convection heaters or IR-lamps. Next the printed carrier film (1) and/or the second, transparent film (2) is coated with an adhesive (4) in coating station (14). Any coating means known in the art can be used such as spraying, roll coating, curtain coating, and the like. Up to this stage, the apparatus is identical to the state of the art apparatuses used for manufacturing in mould labels of the type illustrated in FIG. 1(a), with coating station (14) supplying an adhesive instead of a protective varnish (which may well be the same in some applications). A great advantage of the present invention is that the standard equipment needs very little modifications to be suitable for the manufacturing of the labels of the present invention, as explained below.

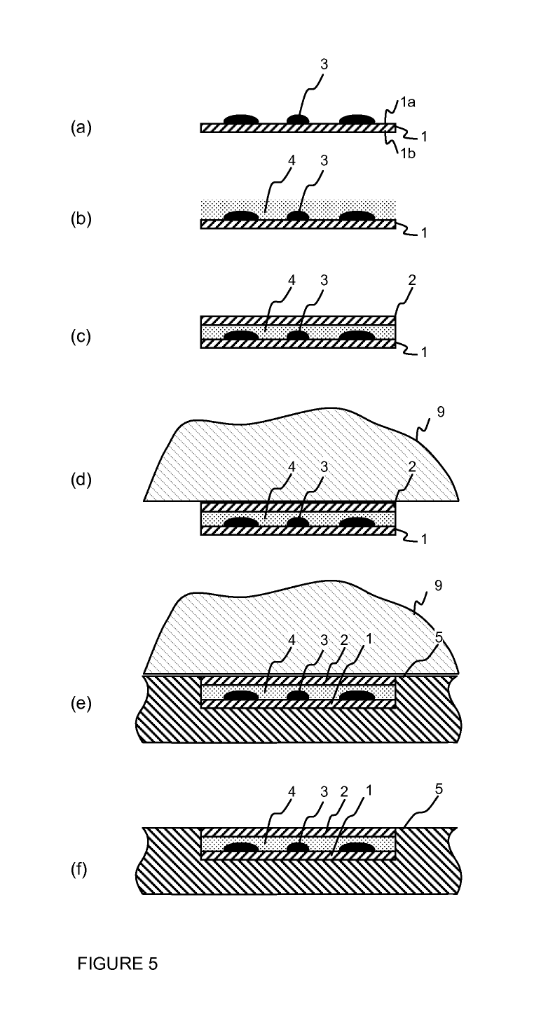

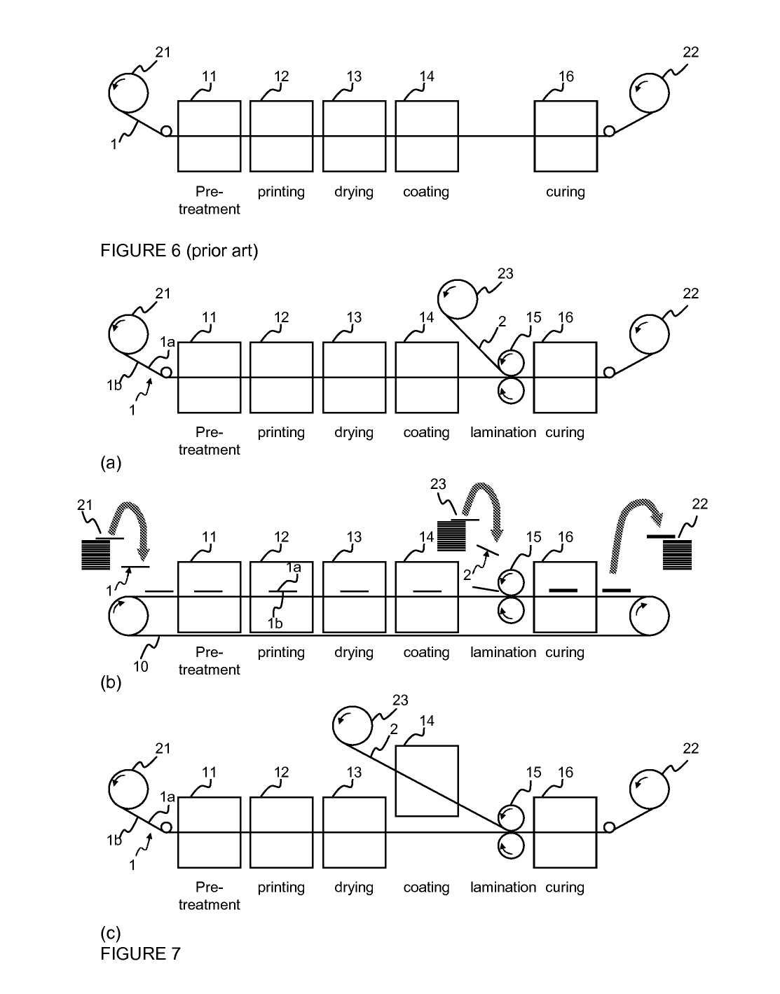

Downstream from the coating station (14), a transparent film (2) is supplied continuously from a supply reel (23) to a laminating station (15) where it is laminated onto the printed surface (1a) of the carrier film (1) such that the adhesive (4) is sandwiched between the two films. Laminating station (15) comprises rollers disposed in any configuration known in the art and suitable for the present application. The adhesive (4) and optionally the printing ink if not cured yet, is cured in a curing station (16) comprising any of UV-light lamps or heating means, such as convection heaters or IR-lamps. The latter station is already present and necessary in the prior art apparatus illustrated in FIG. 5 for the manufacturing of labels of the type illustrated in FIG. 1(a) for curing the varnish prior to rewinding the thus produced labels on a collection reel (22). Prior to use or even just after the curing station (16) the labels can be cut to the desired dimensions off the continuous film thus manufactured.

Alternatively, the process can be carried out on individual pre-cut carrier films as illustrated in FIG. 7(b), by replacing in supply unit (21) the reel discussed above by a stack of pre-cut carrier films which are delivered by means known in the art to a conveying means (10) such as a continuous belt or individual moving trays, driving the carrier film swatches through the different stations mentioned above. Similarly, the reel (23) supplying the second, transparent film (2) is replaced by a stack of pre-cut films, matching the shape and size of at least the printed area of the carrier film swatches coupled with a delivery unit. Finally, the laminated labels are collected and stacked at collection station (22).

(b) In Mould Labelling

The in mould labels of the present invention can be used in any moulding process of polymeric articles, like compression moulding, injection moulding, blowmoulding, rotomoulding, thermoforming, and even calendering. It is, however, most advantageously used in applications such as injection moulding and blowmoulding, regardless of whether thermoplastic melts or reactive resins are used. The labels must be placed into the mould, the transparent film (2) laid against a wall (9) thereof as illustrated in FIG. 5(d). The positioning of the label is of high importance for the quality of the final product. The label is held in place against the mould wall (9) by surface tension. As important shear stresses may be induced on the label upon injecting a melt into the mould or blowing a polymeric parison therein, it may be necessary to temporally enhance the adhesion of the label to the mould wall, lest the label would move during the manufacturing of the article.

Several solutions exist to temporally fix the IML to the mould wall. For instance vacuum may be applied between the mould wall and the IML. This solution is very efficient but requires more complex mould designs and an excellent coordination between vacuum application/release cycles and moulding cycles. A very advantageous alternative is to electrostatically charge the labels, for instance while a label is transferred from the supply stack into the mould. The electrostatic charge permits the label to perfectly adhere to, and follow the contours of the mould wall (9). The structure of the IML of the present invention allows the labels to maintain their electrostatic charges longer than any other IML made of the same materials, because the usually more conductive inks and dyes of the printed pattern are separated from the metallic wall (9) of the mould by a dielectric layer consisting of the adhesive (4) and the transparent film (2).

In injection moulding, a polymer melt or a reactive resin is injected into the mould under high pressure pressing the label against the wall (9) to form the polymeric article (5) incorporating the label in the structure thereof. Adhesion is formed between the backing of the label and the article (5).The injected polymer is at high temperature (above melting temperature for thermoplastics) whereas the mould walls are cooled. The temperature of the injected plastic, and the mould walls must be carefully optimized as a function of the materials used in the IML, and in particular the material of the film (1) or (6) in contact with the article (5). Contrary to what is sometimes believed, it is not essential that the backing of the label partially melts to ensure a good adhesion thereof to the manufactured article (5). Without wishing to be bond by any theory, it is believed that an interphase region is formed comprising crystals crossing across the interface. The crystals from the backing of the label may be formed by re-crystallisation upon contacting the hot melt of the article, without necessarily having to melt. It is believed that macromolecular diffusion across the interface is too slow to have any significant effect in the present process, since an injection moulding cycle is of the order of the second or even less.

As suggested in EP-A-1176003 the backing surface of the label can be provided with an uneven surface by e.g., embossing, yielding a higher interfacial area and some mechanical interlocking with the polymeric article (5) to enhance adhesion.

Any injectable polymeric material can be used in the present application, be it thermoplastic or thermosetting resins. Preliminary tests must be carried out to ensure optimal integrity of the label during injection moulding and perfect adhesion thereof to the polymeric article. Good results are usually obtained when similar materials are used for the label backing (carrier film (1) or additional layer (6)) and the article, in terms of both thermal and adhesive compatibility, but this is not essential to the invention as good adhesion can also be obtained with quite dissimilar materials. Many injection moulded articles are made of polypropylene or polyethylene. For economical and compatibility considerations a label consisting of PP or PE films would be advised in this case. Good results were obtained with paper labels applied to polystyrene articles; similarly polystyrene labels showed good adhesion to ABS articles.

Most of what was explained with respect to injection moulding applies to blowmoulding applications, The parison of course, though hot, is not in a molten state further confirming that partial melting of the label backing is not essential.

The article is then extracted from the mould and a polymeric article provided with the wear- and tear-resistant label of the present invention integrated therein is obtained. The list of applications for the label of the present invention is infinite. The label of the present invention is particularly well suited for applications submitted to heavy stresses in terms of wear, radiations, or thermal cycles. For example, injection moulded polymeric containers for industrial and domestic storage of foodstuff or other goods, which can be transferred from freezing temperatures in a freezer to the microwave radiations of an oven, and subsequently washed in a dishwasher; plastic bottle crates and other packaging which are stored in open air and handled roughly; they could advantageously be provided with an electronic transponder to facilitate the logistics involved with large storage volumes; plastic suitcases which are so often mishandled in airports; vehicle parts exposed to solar UV-radiation, to chips impacts, car wash brush rubbing; etc. Other applications concern blowmoulded bottles and hollow containers, typically the ones returned for washing and further use, or for laboratory or medical applications where reliable labelling is essential and exposure to solvents is possible; plastic bags, e.g., as supplied by shops with their publicity durably visible on their sides or garbage bags, etc.

### EXAMPLES

(a) IML Manufacturing

An IML according to the present invention was manufactured as follows. A decorative pattern was printed positively on a non pre-treated 50 μm PP solid film (1) well suited for traditional IML applications with traditional offset UV inks (UV rays drying). The printed pattern covered 100% of the label with a high density of ink.

A solvent based adhesive was applied on a second, 20 μm PP transparent solid film (2); the coated transparent film (2) was then dried through a 5 meters long drying tunnel and subsequently laminated onto the printed surface (1a) of the printed film (1). The thus obtained IML's were left 24 h to complete the curing/drying process.

(b) Moulding of the IML

A number of labels were die-cut from the reel (22) and were transferred onto an inner wall of an injection mould designed for a food long life transparent PP-container. After injecting the part, the IML showed a perfect adhesion to the moulded part. No undesired effect by the lamination film (2) was observed; on the contrary, the lamination film (2) yielded an enhanced aspect of brilliance and transparency, thus offering the best visibility of the printed pattern.

(c) Ageing Test

A number of thus labelled finished articles were washed 150 times at 65° in a dish-washing machine including all the common domestic chemical agents used in order to obtain perfectly washed dishes. The visual aspect of the labels was not altered at all after the test, neither in respect of the colours and shine of the pattern.

The containers were then filled with water and placed in a microwave oven during 15 min. The water temperature was 90° C.; the container was than placed in a deep-freezer at a temperature of −20° C., until the ice reached that temperature. This cycle was repeated ten times and after each cycle the visual aspect of the label was observed. Here again, the labels maintained their original aspect, showing perfect adhesion to the container, perfect brilliance of the pattern, no ink deterioration, all this confirming that the described process perfectly protects the IML labels

1. In mould label comprising a polymeric or cellulosic carrier base film having a first decorative surface and a second, backing surface, said label comprising a pattern printed on said first decorative surface thereof, said printed first surface being laminated with a transparent protective top film, affixed thereto by means of an adhesive, the printed pattern being visible through said transparent protective top film.

2. An in mould label according to claim 1 wherein the carrier base film is made of a material selected from paper, cardboard, polyolefins like PE or PP, polyesters like PET or PEN, polyurethanes, polystyrenes like ABS, polyvinyl chloride (PVC);
polyamides; epoxies; and combinations, blends, and/or copolymers thereof

3. An in mould label according to claim 1 wherein the protective top transparent film is made of a material selected from polyolefins like PE or PP, polyesters like PET or PEN, polyurethanes, polystyrenes like ABS, polyvinyl chloride (PVC);
polyamides; epoxies; etc., and combinations, blends, and/or copolymers thereof.

4. An in mould label according to claim 1 wherein the carrier base film has a thickness comprised between 20 and 150 μm, preferably between 40 and 80 μm, and most preferably between 45 and 75 μm.

5. An in mould label according to claim 1 wherein the protective top transparent film has a thickness comprised between 20 and 150 μm, preferably between 20 and 50 μm.

6. An in mould label according to claim 1 wherein the protective top transparent film comprises additives selected from the group of:
(a) additives which react to changes in pH, temperature, moisture, or light;
(b) colouring dyes or pigments;
(c) barriers to UV-light, to solvents or gases.

7. An in mould label according to claim 1 wherein the protective base film comprises on its second, backing surface an adhesion enhancing layer in the form of a resin coat or a polymeric film laminated thereon.

8. An in mould label according to claim 1 comprising an electronic component located between the carrier base film and the protective base film.

9. An in mould label according to claim 8 wherein the protective top transparent film further comprises a printed area masking said electronic component.

10. An in mould label according to claim 8 further comprising a third film located between the carrier base film and the protective top film and comprising an aperture surrounding and matching a perimeter of the electronic component compensating at least partly the thickness of said electronic component.

11. Method for manufacturing a printed in mould label comprising the following steps:
(a) optionally pre-treating the surface of a polymeric carrier base film having a first surface and a second surface;
(b) printing a pattern onto the first surface of said carrier base film;
(c) optionally drying or curing the printed pattern;
(d) coating said printed first surface of the polymeric carrier base film, and/or a surface of a second, transparent film with an adhesive;
(e) laminating said protective top transparent film onto the printed surface of the carrier base film, with the adhesive located between the two films;
(f) curing the adhesive; and
(g) collecting the thus obtained multilayered in mould label comprising a pattern visible through the protective top transparent film.

12. A method according to claim 11 wherein the method runs continuously.

13. A method according to claim 11 wherein the method runs on batches of individual labels.

14. A method according to claim 11 wherein the pre-treatment step comprises corona, plasma, or flame treatment of the surface to be printed of the carrier base film.

15. A method according to claim 11 wherein the printed pattern is applied onto the first surface of the carrier base film by any of silk screen printing, gravure printing, offset printing, flexographic printing, ink jet printing, laser printing, thermal transfer, or engraving.

16. A method according to claim 11 wherein adhesive is applied either to the printed surface of the carrier base film or to the protective top transparent film.

17. A method according to claim 11 wherein adhesive is cured by exposure thereof to any of UV-light lamps, convection heating means, radiation heating means, IR-lamps.

18. Method for manufacturing a label coated article comprising the following steps:
(a) providing a label comprising a polymeric or cellulosic carrier base film having a first decorative surface and a second, backing surface, said label comprising a pattern printed on said first decorative surface thereof, said printed first surface being laminated with a transparent protective top film, affixed thereto by means of an adhesive, the printed pattern being visible through said transparent protective top film.
(b) placing said label into a mould for injection moulding, thermoforming, or blowmoulding, the transparent protective top film being in contact with an inner wall of the mould;
(c) injecting a polymeric melt into, or thermoforming or blowing a polymeric preform into said mould, such as to encase the label;
(d) demoulding the thus obtained labelled article.

19. Method according to claim 18 wherein the label is held in place against the inner wall of the mould by electrostatic charges or by vacuum.

20. A polymeric article obtainable by a method comprising the following steps:
(a) providing a label comprising a polymeric or cellulosic carrier base film having a first decorative surface and a second, backing surface, said label comprising a pattern printed on said first decorative surface thereof, said printed first surface being laminated with a transparent protective top film, affixed thereto by means of an adhesive, the printed pattern being visible through said transparent protective top film.
(b) placing said label into a mould for injection moulding, thermoforming, or blowmoulding, the transparent protective top film being in contact with an inner wall of the mould;
(c) injecting a polymeric melt into, or thermoforming or blowing a polymeric preform into said mould, such as to encase the label;
(d) demoulding the thus obtained labelled article.

21. A polymeric article according to claim 20 wherein said article includes one of a container for industrial and domestic storage of foodstuff or other goods and other packaging, a bottle crate; a suitcase; a vehicle part; a bottle, a hollow container; and a plastic bag.
